(19) United States
(12) Patent Application Publication
(10) Pub. No.: US 2026/0034700 A1
(43) Pub. Date: Feb. 5, 2026

(54) METHOD AND APPARATUS FOR PRODUCING LUMBER FROM A TREE TRUNK

(71) Applicant: Gebrüder Linck, Maschinen “Gatterlinck” GmbH & Co. KG, Oberkirch (DE)

(72) Inventor: Robert MAIER, Biberach (DE)

(73) Assignee: Gebrüder Linck, Maschinen “Gatterlinck” GmbH & Co. KG, Oberkirch (DE)

(21) Appl. No.: 19/261,275

(22) Filed: Jul. 7, 2025

(30) Foreign Application Priority Data
Aug. 2, 2024 (EP) 24192585.8

(51) Int. Cl. B27B 1/00; B27B 31/00; B27B 31/06

(52) U.S. Cl. CPC B27B 1/007; B27B 31/003; B27B 31/06

(57) ABSTRACT

A method for producing lumber from a tree trunk, where a machining surface is produced on the trunk by removing a slab region, and where, during a feed movement in a feed direction, the trunk moves toward at least two milling tools, which are each feedable along an infeed axis, whereby two waney regions adjacent to the machining surface are milled out and at least one side product board is profiled, and the side product board is separated from the trunk by a saw cut. During feeding and before profiling the side product board, the trunk is brought from a transport to a machining position by moving the trunk around and/or along an adjustment axis, which runs orthogonally to the feed direction, and, as a result, at least one leading region of the trunk is shifted transversely to the feed direction in the direction of at least one milling tool.

### CROSS-REFERENCE TO RELATED APPLICATIONS

This application claims priority to European Patent Application No. 24192585.8, filed Aug. 2, 2024, which is incorporated herein by reference as if fully set forth.

### TECHNICAL FIELD

The invention relates to a method and an apparatus for producing lumber from a tree trunk.

### BACKGROUND

In industrial wood processing, tree trunks are processed, inter alia, to give boards. It is typical in this context for different cross-sectional regions of such a tree trunk to be used to obtain correspondingly different types of board. Thus, for instance, inner cross-sectional regions are used to obtain what is referred to as main product, while outer cross-sectional regions are used to obtain what is referred to as side product. Here, the main product can comprise one or more main product boards, and the side product can correspondingly comprise one or more side product boards.

To produce side product, at least one side product board is typically profiled directly on the tree trunk. For this purpose, a slab region of the tree trunk is first of all removed and, as a result, at least one machining surface extending along the trunk axis is produced. Such a machining surface typically defines the broad side of a side product board. The tree trunk is then moved in a feed direction toward at least two milling tools, whereby two waney regions adjacent to the machining surface are milled out and two narrow sides of the side product board are defined. By means of a saw cut, the side product board is then separated from the tree trunk.

The above-described processing usually takes place sequentially on a plurality of tree trunks which are moved in the feed direction toward the milling tools and, during this process, have a spacing with respect to one another, which is referred to as a wood gap. To achieve maximum productivity, it is generally desirable to minimize the wood gap between two tree trunks. However, one challenge here consists in the fact that the processed tree trunks and the side product to be profiled can differ greatly from one another in their geometries and dimensions. This has the effect that, before the tree trunk is machined, the milling tools may in some circumstances have to travel long infeed paths in order to be able to profile the side product of the relevant tree trunk in the desired manner. In this context, infeed typically takes place within the wood gap, and it has therefore hitherto been impossible to reduce it arbitrarily.

To achieve a maximum wood yield, it may furthermore be necessary not to profile the side product parallel to the trunk axis of a tree trunk. One way of achieving this is for a tree trunk of this kind to be moved along its trunk axis toward the milling tools and for said milling tools to be shifted along their respective infeed axes during milling. It is thereby possible to produce the side product profile with the desired nonparallel shape relative to the trunk axis of the tree trunk. Depending on how pronounced is the angle between the side product and the trunk axis, the milling tools may also have to travel long infeed paths during milling. This likewise has a disadvantageous effect on the desired reduction of the wood gap since, in order to machine a following tree trunk, the milling tools may be moved back in the opposite direction and likewise have to travel long infeed paths in the process.

### SUMMARY

It is the object of the invention to provide at least one method and one apparatus by which efficiency in the machining of tree trunks can be increased by reducing the wood gap.

The object is achieved by various methods having one or more of the features disclosed herein and an apparatus also having one or more of the features disclosed herein. Advantageous further developments are described below and in the claims.

The method according to the invention is used to produce lumber from a tree trunk, in which at least one machining surface is produced on the tree trunk in a manner known per se by removing a slab region. The tree trunk is moved in a feed direction toward at least two milling tools and, during this process, two waney regions adjacent to the machining surface are milled out, whereby at least one side product board is profiled. During this process, the milling tools can each be fed in along an infeed axis. By means of a saw cut, the side product board is then separated from the tree trunk.

It is essential for the method according to the invention that, during the feed movement and even before the side product board is profiled, the tree trunk is adjusted from a transport position into a machining position. For this purpose, the tree trunk is moved around and/or along an adjustment axis, which runs orthogonally to the feed direction. As a result, at least one leading region of the tree trunk is shifted transversely to the feed direction in the direction of at least one of the milling tools.

The invention is based on the realization that the wood gap between two tree trunks to be processed can be considerably reduced by bringing the tree trunk into a position that enables the infeed path of at least one, preferably two, of the milling tools to be reduced even before the profiling of the side product board. For this purpose, according to the invention, the tree trunk is moved in such a way that the leading region of the tree trunk is moved toward the milling tool, such that said tool has to travel only a short infeed path or preferably no infeed path before it can enter into machining engagement with the tree trunk. In comparison with the conventional method, in which no adjustment of the tree trunk takes place and the milling tools are merely fed in along their infeed axes to enable the side product board to be profiled, a smaller wood gap and thus also high productivity in wood machining can be achieved.

In particular, the shifting of the leading region of the tree trunk takes place at least partially in a plane in which the infeed axis of the at least one milling tool runs, or preferably a plane in which the infeed axes of two milling tools run. Here, the infeed axes of the milling tools preferably each run orthogonally to the feed direction and substantially parallel to the machining surface of the tree trunk when the latter is in the machining position.

The transport position denotes a position of the tree trunk in which the tree trunk is moved in the feed direction before its adjustment into the machining position. The machining position denotes a position of the tree trunk in which the tree trunk is moved toward the milling tools in order to profile the side product board and enters at least by means of the leading region into cutting engagement with at least one of the milling tools. It is within the scope of the invention that the tree trunk remains in the machining position during the profiling of the side product or is moved onward during profiling, in particular into at least one other machining position. In addition, the invention is not restricted to the way in which the transport position and/or the machining position are/is defined. It is therefore conceivable for the transport position and the machining position to differ from one another in an orientation and/or position of the tree trunk relative to the feed direction or a feed axis of the tree trunk. In other words, it is possible for the tree trunk to have a first orientation and/or a first position relative to a feed direction or a feed axis in the transport position, and to have a second orientation and/or a second position relative to the feed direction or the feed axis in the transport position. Corresponding statements can apply to a first machining position and a second machining position during the profiling of the side product.

It is within the scope of the invention for the slab region to be separated from the tree trunk as a coherent slab or to be machined off the tree trunk in the form of chips or in some other comparable form. In particular, it is possible, after the removal of the at least one slab region, for the tree trunk to be in the form of a “model” with two machining surfaces or in the form of a squared piece of timber with four machining surfaces, which are separated from one another in pairs by a waney region of the tree trunk. Here, the waney region denotes a region on the outer periphery of the tree trunk, the character of which is determined by the natural growth of the tree trunk.

In one conceivable embodiment, the tree trunk is oriented in such a way after machining by means of the milling tools and during its feed movement that the machining surface faces sideways from the tree trunk. In other words, the machining surface is therefore, in particular, on a left-hand or right-hand side of the tree trunk and, at least in some region or regions, runs parallel to a direction of gravity. Such an alignment of the tree trunk, in which the side product board to be profiled is arranged on the side of the tree trunk after being profiled, is advantageous since it can fall off by the action of gravity after a saw cut. Since the infeed axes of the milling tools run parallel to the direction of gravity in such an alignment of the tree trunk, it is necessary for the execution of the method according to the invention to move the tree trunk at least partially counter to the direction of gravity in order to adjust it in accordance with the invention and thereby reduce the wood gap.

In order to avoid a movement of the tree trunk counter to the direction of gravity, the tree trunk may also be present in such a way that the machining surface is oriented substantially transversely to the direction of gravity, in particular therefore faces upward or downward, and the infeed axis of at least one of the milling tools runs transversely to the direction of gravity. For adjustment of the tree trunk, during which the leading region is moved transversely to the feed direction in the direction of the milling tool, the tree trunk can be moved transversely to the direction of gravity and, in particular, does not have to be raised during the adjustment around and/or along the infeed axis. This allows particularly energy-efficient process management.

The side product board can be part of a side product or of a side product package comprising one or more side product boards. The machining surface which is produced by removing the slab region can at least partially define a long broad side of a side product board. By milling out the waney regions, it is possible, in particular, to produce two long narrow sides of a side product board.

In addition, the invention is not restricted to a geometry of the side product board to be profiled. On the contrary, it is within the scope of the invention that the side product board can be profiled with a rectilinear shape or approximately with a crooked-edge shape, where the side product board is curved around an axis of curvature which runs perpendicularly to the machining surface, or with a crooked-surface shape, where the side product board is curved around an axis of curvature which runs substantially parallel to the machining surface. The only point of relevance is that the tree trunk is brought with its leading region into spatial proximity with at least one of the milling tools so that said tool has to travel as short an infeed path as possible to enter into machining engagement with the tree trunk in the machining position thereof. It is also within the scope of the invention for the method to be carried out on a tree trunk with a substantially straight trunk axis or on a tree trunk with a curved trunk axis. In particular, a curved shape of the side product or of the side product board to be profiled and/or of the trunk axis can lie in a plane in which the infeed axis of at least one milling tool also runs.

The tree trunk is preferably adjusted around and/or along the adjustment axis into the machining position in dependence on a position and/or orientation of a leading tree trunk. This makes it possible to set the machining position of the following tree trunk in such a way that the infeed position of the milling tool which machines the leading tree trunk has to be changed only slightly or not at all. This results in different advantages, depending on the shape of the side product board produced from the leading tree trunk.

In one advantageous embodiment, at least two tree trunks are moved successively in the feed direction, wherein one side product board on each of the two tree trunks is profiled by means of the at least one milling tool. During the profiling of the side product board of a first tree trunk of the two tree trunks, at least one of the milling tools is fed in along its infeed axis. Before the profiling of the side product board of a second tree trunk of the two tree trunks, the second tree trunk is brought into the machining position by moving the tree trunk around and/or along the adjustment axis, which runs orthogonally to the feed direction, and, as a result, at least a leading region of the second tree trunk is moved in the direction of the at least one milling tool. The milling tool is preferably not fed in while it is in a wood gap between the first tree trunk and the second tree trunk.

The above-described embodiment of the method is advantageous if the side product board of the first tree trunk is to be profiled with a nonparallel shape with respect to the trunk axis and the milling tool is fed in during the profile machining in order to achieve this shape of the side product board with respect to the trunk axis. In order to reduce the wood gap with respect to the second, following tree trunk, the leading region of the tree trunk can be shifted transversely to the feed direction into a position in which the milling tool is already located due to the machining of the leading, first tree trunk. As a result, the milling tool can preferably not be fed in and can enter into separating engagement with the second tree trunk with a minimal wood gap immediately after machining the first tree trunk. To this extent, the second tree trunk can be regarded as the tree trunk machined according to the invention.

It is likewise conceivable for at least two tree trunks to be moved successively in the feed direction, wherein one side product board on each of the two tree trunks is profiled by means of the two milling tools. After the profiling of the side product board on the first of the two tree trunks, at least one of the milling tools is fed in along its infeed axis. Before the profiling of the side product board on the second of the two tree trunks, the second tree trunk is brought into the machining position by moving it around and/or along the adjustment axis, which runs orthogonally to the feed direction, and, as a result, the leading region of the second tree trunk is shifted transversely to the feed direction in the direction of the milling tool. In particular, the leading region of the tree trunk is moved in the opposite direction to the milling tool. The milling tool is preferably fed in while the milling tool is in a wood gap between the first tree trunk and the second tree trunk.

According to the above-described further development, the milling tool can be fed in in a wood gap between the first and the second tree trunk in order to get into a position which enables it to enter into machining engagement with the second tree trunk. At the same time, the leading region of the second tree trunk can be adjusted counter to the infeed movement of the milling tool, thus giving the abovementioned preferred opposed movement. In this way, the infeed path of the milling tool can be significantly reduced in comparison with a method in which the tree trunk is not shifted between a transport position and a machining position, thereby enabling a corresponding shortening of the wood gap to be achieved. To this extent, in this context too, the second tree trunk can be regarded as the tree trunk machined according to the invention.

In one advantageous further development, the tree trunk is brought into the machining position by rotating it around a rotation axis which is orthogonal to the feed direction. At least one of the milling tools is fed in along its infeed axis, which runs orthogonally to the feed direction of the tree trunk and the rotation axis, before the milling of the tree trunk.

Rotation of the tree trunk is advantageous in order, as already explained above, to move at least a leading region of the tree trunk toward one of the milling tools, thereby enabling said tool to travel a shortened infeed path for the milling of the tree trunk before it enters into machining engagement with the tree trunk. The rotation axis is a possible adjustment axis for the purposes of the invention.

In principle, the advantageous further development is not limited to the angle through which the tree trunk is rotated in order to get from the transport position to the machining position. On the contrary, it is within the scope of the advantageous further development for the tree trunk to be rotated in such a way from the transport position into the machining position during the feed movement that the extension axis of the side product board to be profiled can be aligned substantially parallel or non-parallel to the feed direction.

In one advantageous further development, before the profiling of the at least one side product board, a cutting solution for the tree trunk is determined, comprising a substantially rectilinear side product shape on the tree trunk, which runs at an angle, in particular to a trunk axis, and the tree trunk is rotated around the rotation axis in such a way that a setpoint extension axis of the side product board in the machining position of the tree trunk is oriented parallel to the feed direction. The side product board is profiled in accordance with the cutting solution by moving the tree trunk in the machining position toward at least one of the milling tools and by the milling tool being fixed in relation to its infeed axis during the profiling of the side product board.

The above-described further development is advantageous, in particular, if the setpoint extension axis of the side product board is oriented at an angle to the trunk axis in a plane which runs parallel to the machining surface of the tree trunk. By rotating the tree trunk around the rotation axis, the side product board can be aligned along the feed direction, and therefore no infeeding of the milling tool is required during the milling of the tree trunk in order to be able to profile the side product board of the tree trunk in accordance with the cutting solution. On the contrary, the desired side product shape on the tree trunk in accordance with the cutting solution can be obtained purely as a result of the feed movement of the tree trunk toward the milling tools.

In another advantageous further development, before the profiling of the side product board, a cutting solution for the tree trunk is determined, comprising a substantially rectilinear side product shape on the tree trunk, which runs at an angle, in particular to a trunk axis, and the tree trunk is rotated around the rotation axis in such a way that a setpoint extension axis of the side product board is not oriented parallel to the feed direction.

If the setpoint extension axis of the side product board is not oriented parallel to the feed direction in the machining position, the side product board can be produced in accordance with the cutting solution or while deviating from the latter. For this purpose, the at least one milling tool can be fed in or can be fixed in relation to its infeed axis during the profile machining of the tree trunk.

In one advantageous further development, in which the side product board is profiled in accordance with the cutting solution, at least one of the milling tools is fed in relative to its infeed axis during the milling of the tree trunk. In particular, the infeed can take place in dependence on a feed rate and length dimension of the tree trunk in order to profile the side product board in a straight line and, in accordance with the cutting solution, with the desired alignment relative to the tree trunk.

In another advantageous further development, the side product board is profiled in a manner which deviates from the cutting solution, in that at least one of the milling tools is fixed in relation to an infeed axis during the profiling of the side product board, i.e. is not fed in further. Admittedly, during this process, the side product board is profiled with a shape which deviates from the setpoint extension axis, and this may result in losses in terms of wood yield. However, experiments carried out by the applicant have shown that such losses may be acceptable in order to achieve high plant productivity by virtue of a small wood gap.

Inter alia, the cutting solution can indicate a position of a side product board relative to the trunk geometry. In this context, the setpoint extension axis can be regarded as a central axis of the side product board to be profiled. The cutting solution can be determined by measuring the tree trunk by means of a profile sensor and transferring the measurement data obtained during this process to a computing unit, which outputs the cutting solution for achieving an optimum wood yield.

In one advantageous further development, the milling tools are each designed as rotating milling heads, the rotation axes of which in each case enclose an acute angle with a plane which is oriented orthogonally to the feed direction. In particular, this acute angle can be set to a fixed value.

The further development described above is based on the realization that the removal of waney regions by cutting is usually associated with finish-cutting on the profiled side product board if the milling tools and, in particular, the cutting edges arranged thereon are guided parallel to the side product board, in particular to the narrow sides thereof. In order to prevent this, the milling tools can be set obliquely relative to the feed direction, resulting in the abovementioned acute angle between the axes of rotation of the milling heads and a plane which is oriented orthogonally to the feed direction. By means of selective wood alignment, during which a tree trunk is rotated around a rotation axis, it is furthermore possible to eliminate readjustment of the acute angle during the milling of the tree trunk, and therefore, as indicated above, the acute angle can be set to a fixed value. This is associated with design advantages in the mounting of the milling tools.

The adjustment according to the invention of the tree trunk into the machining position is not only advantageous if the tree trunk has just one side product board to be profiled on one side of the tree trunk. There are also advantages if the tree trunk is to be provided with two side product profiles on two opposite sides.

In one advantageous further development, it is therefore possible, by removing two slab regions, to produce two machining surfaces which face in opposite directions on the tree trunk. The tree trunk is moved in a feed direction toward at least four milling tools and, during this process, four waney regions adjacent to the machining surfaces are milled out, whereby two side product boards on the tree trunk are profiled. By means of two subsequent saw cuts, two side product boards are separated from the tree trunk. Before the profiling of the two side product boards, the tree trunk is brought from the transport position into the machining position by moving the tree trunk around and/or along the adjustment axis and, as a result, at least the leading region of the tree trunk is shifted transversely to the feed direction in the direction of at least two of the milling tools.

Adjustment of the tree trunk with two oppositely facing machining surfaces from the transport position into the machining position can take place in accordance with the above statements. It is particularly advantageous if the setpoint extension axes of the side product boards extend substantially parallel to one another and the side product boards have substantially the same width, such that the infeed paths for all the milling tools used to profile the side product boards can be identical and, by virtue of the method described here involving adjustment of the tree trunk, can be relatively short. The parallel shape of the side product boards can be present, in particular, in a plane which runs parallel to the machining surfaces at which the side product boards are to be profiled.

Owing to the natural growth of tree trunks, however, it is conceivable that the setpoint extension axes of side product boards on the oppositely facing sides of the tree trunk will not run parallel to one another according to the cutting solution, in particular running in a common plane that is oriented parallel to the machining surfaces.

In one advantageous further development, therefore, before the profiling of the longitudinal sides of the side product boards, a cutting solution for the tree trunk is determined, comprising two substantially non-parallel side product shapes in each case along the setpoint extension axis thereof, and the tree trunk is rotated around the rotation axis in such a way that, in the machining position, the two setpoint extension axes define an angular range which encloses the feed direction. In particular, in the machining position the tree trunk is oriented along an angle bisector between the setpoint extension axes of the side product boards and parallel to the feed direction. The non-parallel path of the setpoint extension axes is preferably in a plane which runs substantially parallel to the two machining surfaces.

In one advantageous further development, the tree trunk is machined by means of the milling tools in accordance with the cutting solution, and the side product boards are produced in accordance with the setpoint extension axes by feeding in the milling tools transversely to the feed direction and along their respective infeed axes during the milling of the tree trunk. It is thereby possible therefore to profile the side product boards in the manner envisaged in the cutting solution determined, thus enabling an optimum wood yield to be achieved. In particular, infeeding takes place in dependence on a feed rate of the tree trunk and the paths of the setpoint extension axes relative to the feed direction.

In another advantageous further development, the tree trunk is machined by means of the milling tools in a manner which deviates from the cutting solution, in that the milling tools, which serve to profile two different side product boards, are fixed along their respective infeed axes during milling, and the side product boards are each produced with actual longitudinal extension axes which each have an angular deviation from the respective setpoint longitudinal extension axis.

In this context, experiments by the applicant have shown that adjustment of the tree trunk into the machining position is advantageous even if the side product boards are not profiled with the optimum alignment relative to the trunk axis. Instead, it is possible to consciously accept a deviation from the ideal cutting solution, with the milling tools not being fed in during milling. This is conceivable, for instance, when the angle between the setpoint longitudinal extension axes of the side product and the trunk axis is in each case relatively small, thus enabling the losses of wood yield to be accepted in favor of a small wood gap.

In particular, the feed direction can be oriented along an angle bisector between the setpoint longitudinal extension axes of the side product boards in the machining position. In this case, the angular deviation during milling of the tree trunk can in each case correspond to half the angle between the setpoint longitudinal extension axes of the side product boards.

In one advantageous further development, the tree trunk is brought at least partially into the machining position by being shifted along a translation axis, which runs orthogonally to the feed direction. The translation axis is a possible adjustment axis for the purposes of the invention.

Translational adjustment of the tree trunk is advantageous, in particular, if the side product which is to be profiled on the tree trunk has a setpoint extension axis which is already oriented parallel to the feed direction in the transport position of the tree trunk, i.e. before its adjustment, and at least one milling tool must be fed in before the profiling of the side product board in order to profile the side product board in accordance with the desired dimensions.

In one advantageous further development, before the profiling of the at least one side product board, a cutting solution for the tree trunk, in particular the second tree trunk, is determined, which comprises a side product shape on the tree trunk, in particular on the second tree trunk. A setpoint extension axis of the side product board runs substantially parallel to a trunk axis. The tree trunk is brought into the machining position by shifting the setpoint extension axis of the tree trunk along the translation axis in dependence on a leading tree trunk.

The further development described above is based on the realization that a translational adjustment of the tree trunk may be advantageous if the side product board to be profiled runs substantially parallel to the trunk axis and, while achieving the above-described advantages, can be profiled with a small wood gap if it is brought into its machining position in accordance with the position of the leading tree trunk.

In one advantageous further development, at least two tree trunks that follow one another in the feed direction are adjusted in such a way that the side products to be profiled are aligned along a common machining axis before the tree trunks are each moved toward the milling tools.

In one advantageous further development, the tree trunk is shifted around and/or along at least one adjustment axis, which runs orthogonally to the feed direction, relative to the milling tools in dependence on a position and/or orientation of another, leading tree trunk, before the tree trunk is moved in the feed direction toward the milling tools.

In one advantageous further development, the tree trunk is moved in the feed direction by means of a plurality of feed roller pairs, of which at least two feed roller pairs are arranged spaced apart along the feed direction, and the tree trunk is brought into the machining position by shifting at least one of the feed roller pairs relative to the respective other feed roller pair and/or shifting the at least two feed roller pairs jointly transversely to the feed direction.

The feed rollers of a feed roller pair can each be driven to perform a rotational movement and can impart the feed movement to the tree trunk via their lateral surfaces. In addition, the feed rollers can each be mounted so as to be adjustable transversely to the feed direction in order to be able to transmit an adjusting movement to the tree trunk during their rotational movement.

For a translational movement of the tree trunk, it is advantageous if at least one feed roller pair is shifted by an adjustment travel. In order to prevent unwanted rotation of the tree trunk, another feed roller pair can be shifted by the same adjustment travel. For a rotational movement of the tree trunk, it is advantageous if one feed roller pair is shifted by an adjustment travel relative to another feed roller pair.

It is within the scope of the advantageous further development that the feed roller pairs are each coupled to at least one rotation drive and one adjustment drive, which, for their part, are controlled by means of a controller. Control of the rotation drive and of the adjustment drive can take place in dependence on the cutting solution and, in particular, in dependence on whether the tree trunk is to be profiled in accordance with the cutting solution or while deviating therefrom. The tree trunk is preferably adjusted along the feed direction and/or transversely to the feed direction by means of more than two feed roller pairs in order to be brought from the transport position into the machining position.

The object of the invention is also achieved by a further method disclosed herein. This is used to produce lumber from a tree trunk and, in particular, can be carried out alone or in addition to the method already described above or one of the advantageous further developments thereof.

According to the invention, at least one machining surface is produced on the tree trunk by removing a slab region. During a feed movement in a feed direction, the tree trunk is moved toward at least two milling tools, which can each be fed in along an infeed axis, whereby two waney regions adjacent to the machining surface are milled out and at least one side product board is profiled. By means of a saw cut, the side product board is separated from the tree trunk. Before the profiling of the side product board, a cutting solution for the tree trunk is determined, comprising a side product shape. In a first machining position, the tree trunk is moved toward the milling tools and, during the profiling of the side product board, is brought from the first machining position into a second machining position. The side product board is profiled in accordance with the cutting solution by feeding in the two milling tools along their infeed axes during the profiling of the side product board.

The method described above is based on the realization of the applicant that it may be advantageous if, after the profiling of the side product board, the trunk axis of the tree trunk is in a desired alignment relative to the feed direction of the trunk. This is the case for instance if, after profiling, the tree trunk is machined by means of some other separating means which cannot be adjusted or can be adjusted only with great effort to enable it to be adapted to the geometry and dimensions of the tree trunk, and it may therefore be necessary to align the tree trunk with reference to the trunk axis, at least in the region with which the separating means is in engagement with the tree trunk. In order to be able to profile the side product in accordance with the cutting solution during this process, provision is made according to the invention for the two milling tools to be fed in during the profiling of the side product board and the movement of the tree trunk from the first into the second machining position. This makes it possible to profile the side product in the manner desired even though the tree trunk is rotated around the rotation axis while it is being machined.

It is advantageous that, before the profiling of the at least one side product board, a cutting solution for the tree trunk is determined, comprising a substantially rectilinear side product shape on the tree trunk, which is oriented at an angle to a trunk axis, and, in the first machining position, in which the setpoint extension direction of the side product board is oriented parallel to the feed direction, the tree trunk is moved toward the milling tools and, during the profiling of the side product board, is brought from the first machining position into a second machining position, in which the trunk axis is oriented parallel to the feed direction, wherein the side product board is profiled in accordance with the cutting solution by feeding in the two milling tools along their infeed axes during the profiling of the side product board.

The process management described above is conceivable when the tree trunk is to be profiled in the manner described above and the side product board is separated from the main product immediately thereafter by means of a saw cut in what is referred to as the preliminary cut. In particular, the tree trunk can be moved along its trunk axis toward the first separating means used during this process, in particular a preliminary cut sawing device. The trunk axis of the tree trunk is preferably positioned in such a way in the second machining position that the extension axis of the side product board is aligned centrally between two saw blades by means of which the side product board is separated.

During this process, the main product of the tree trunk to be profiled can be in contact circumferentially with a plurality of side product boards, of which, in accordance with the above statements, at least one side product board is oriented at an angle to the trunk axis and is separated from the main product of the rest of the tree trunk as a result of the preliminary cut. The other side product boards, which are usually arranged at an angular offset of about 90 degrees thereto, are then likewise profiled and separated from the main product in what is referred to as a final cut. In contrast to the preliminary cut, cutting up of the main product by means of a plurality of saw blades oriented parallel to one another takes place here simultaneously with the saw cut which separates the side product board from the main product. To avoid exposing the saw blades to excessive bending stress during the final cut on account of trunk curvature, it may be advantageous in the case of curved trunks to selectively align the tree trunk before the final cut as well.

For this purpose, in one advantageous further development, before the profiling of the at least one side product board, a cutting solution for the tree trunk is determined, wherein the side product shape and the trunk shape are curved, and, in the first machining position, the tree trunk is moved toward the milling tools and, during the profiling of the side product board, is brought from the first machining position into a second machining position, in which the trunk axis and/or the side product board are/is oriented parallel to the feed direction in a region which lies behind the profiling tools with respect to the feed direction, wherein the side product board is profiled in accordance with the cutting solution by feeding in the two milling tools along their infeed axes during the profiling of the side product board.

In particular, a second separating means, in particular a final-cut sawing device, by means of which the final cut is made, is arranged in the region which lies behind the profiling tools with respect to the feed direction.

As mentioned above, the object of the invention is also achieved by an apparatus having one or more of the features disclosed herein.

The apparatus according to the invention is used to produce lumber from a tree trunk, in particular by carrying out the method according to the invention or an advantageous further development thereof. The apparatus comprises a separating means which is configured to separate a slab from a tree trunk and to produce at least one machining surface, and a feed means, which is designed to impart a feed movement to the tree trunk along a feed direction. The apparatus furthermore comprises two milling tools, which are arranged in such a way that, during the feed movement, the tree trunk is moved toward the milling tools in such a way that two waney regions adjacent to the machining surface are milled out and the longitudinal sides of a side product board are thereby profiled. The apparatus also comprises a sawing means, which is designed to separate the side product board from the tree trunk. It is essential that the feed means is designed to adjust the tree trunk around and/or along at least one adjustment axis, which runs orthogonally to the feed direction, from a transport position into a machining position and thereby enable at least one leading region of the tree trunk to be shifted transversely to the feed direction in the direction of at least one of the milling tools, in particular parallel to an infeed axis of the milling tool.

The apparatus according to the invention is preferably suitable for carrying out a method according to the invention or an advantageous further development thereof. To this extent, the statements relating to the method according to the invention and to its advantageous further developments apply in a corresponding manner.

The feed means preferably comprises a plurality of feed rollers, which can each be driven to perform a rotation movement in order to bring about a feed movement of the tree trunk and can be shifted transversely to the feed direction in order to bring about an adjustment of the tree trunk. It is within the scope of the advantageous further development that the feed rollers are individually controllable or are at least mechanically coupled to one another in pairs. In particular, it is conceivable for a plurality of feed roller pairs to be adjustable independently of one another transversely to the feed direction.

A drive system is preferably provided for the purpose of bringing about the rotation movement and/or the adjusting movement of the feed rollers. In particular, a control unit can be provided in order to control the drive system, in particular in accordance with a control program which indicates a dependence between a required feed roller movement for adjustment of a machining position of the tree trunk. The feed roller movement, which is adjustable by means of the control unit, comprises, in particular, a rotation movement at least of one roller and/or an adjusting movement transversely to the feed direction of the tree trunk, in particular in combination with a conveying movement of at least one other feed roller. It is within the scope of the advantageous further development that the control unit is designed to determine a cutting solution for the tree trunk. For this purpose, the control unit is preferably connected by signals to one or more profile sensors, by means of which a trunk geometry can be determined.

### BRIEF DESCRIPTION OF THE DRAWINGS

Advantages and possible configurations of the invention are explained below by means of exemplary embodiments and the figures.

In the drawings:

FIGS. 1A-1C show a method in which a tree trunk is rotated from a transport position into a machining position before the profiling of a side product board;

FIGS. 2A-2D show a method in which, during the profiling of a side product board, a tree trunk is rotated from a first machining position into a second machining position for a preliminary cut;

FIGS. 3A-3D show a method in which, during the profiling of a side product board, a tree trunk is rotated from a first machining position into a second machining position for a final cut;

FIG. 4 shows a method in which two successive tree trunks are each rotated from a transport position into a machining position before the profiling of a side product board;

FIGS. 5a-5B show a method in which a tree trunk is rotated into a machining position before the profiling of two side product boards situated on opposite sides;

FIGS. 6A-6B show a method in which a tree trunk is adjusted in translation into a machining position before the profiling of a side product board;

FIG. 7 shows a method in which two successive tree trunks are each adjusted in translation into a machining position before the profiling of a side product board.

### DETAILED DESCRIPTION

During the processing of tree trunks into boards, different cross-sectional regions are used to obtain different types of board. In this context, an inner cross-sectional region typically serves to produce what is referred to as a main product or main product boards included therein, and an outer cross-sectional region is used to obtain what is referred to as side product or side product boards included therein. The tree trunk is usually profiled by means of milling tools in order to produce at least one side product board and then to separate said board from the tree trunk.

In the case of the apparatuses used for this purpose, tree trunks are usually moved successively and with a spacing, referred to as a wood gap, toward the profiling tools for machining. As a result, these come into machining engagement with the tree trunk and mill out two previously produced waney regions, thereby profiling the side product. In order to achieve high productivity in machining tree trunks in this way, one customary goal is to reduce the wood gap.

In the case of fluctuating trunk geometries, however, it is necessary to individually feed in the milling tools used for profiling along their respective infeed axes, at least before profiling, in order to enable the side product to be profiled with different widths and shapes. During this process, the milling tools are each brought into an infeed position, in which they should come into engagement with a leading end of the tree trunk in order to mill out the waney regions. The milling tools are usually fed in while the milling tools are located between a tree trunk that has already been profiled and one which has yet to be profiled, i.e. in the wood gap. Since, at a given feed rate of the tree trunks, the wood gap determines the time within which infeed can take place, it was not previously possible to reduce this as desired.

In addition to the width of the side product, its desired alignment relative to the trunk axis also affects the hitherto possible reduction in the wood gap. If, namely, in order to increase the wood yield, the side product is to be profiled with a shape that is not parallel to the trunk axis, the milling tools must be adjusted during the feed movement of the tree trunk and the profiling process. If the side product is at a very pronounced angle to the trunk axis, the milling tools must travel long infeed paths and may have to be moved in the opposite direction in order to machine a following tree trunk. A sufficiently large wood gap is likewise required for this purpose.

With the method described below, it is possible to reduce the wood gap and thereby to significantly increase productivity in the profiling of side product.

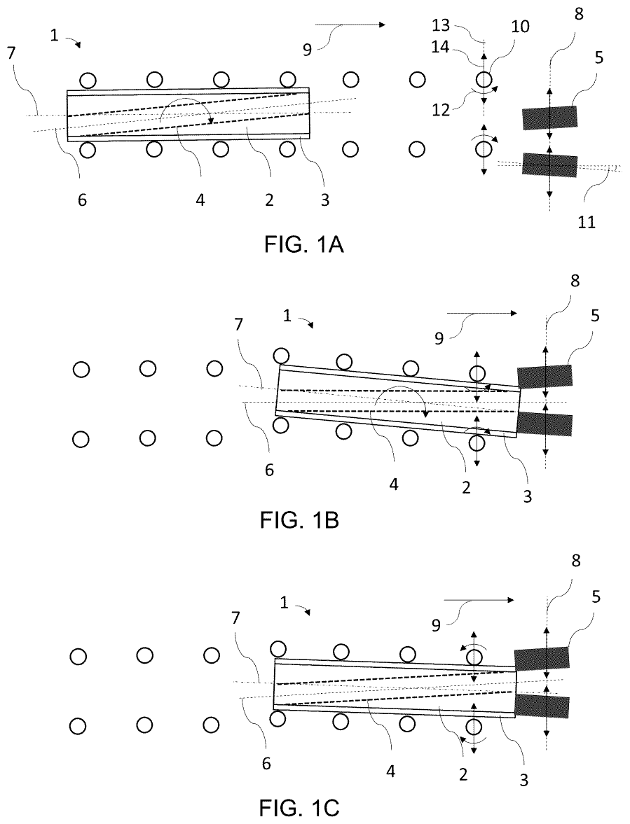

FIG. 1A shows a tree trunk 1, which has a previously produced machining surface 2 and two waney regions 3 adjacent thereto. In the figures shown here, the tree trunk 1 can be, in particular, in the form of a model with two machining surfaces 2 or in the form of a squared piece of timber with four machining surfaces 2, which are distributed around the outer periphery and are separated from one another in pairs by a waney region 3. To produce a side product board 4, this should be profiled on the tree trunk 1 using two milling tools 5. This is followed by a saw cut, by means of which the previously profiled side product board 4 is separated from the tree trunk 1.

Before the machining of the tree trunk 1, the side product board 4 to be profiled has a setpoint extension axis 6, which is oriented at an angle to the trunk axis 7 in the plane of the image in FIGS. 1A-1C, in which the machining surface 2 is also situated.

For typical side product profiling by means of conventional methods, the milling tools 5 would first of all have to be fed in along their respective infeed axes 8 from the position shown in FIG. 1A in such a way that they are moved in the direction of the leading end of the tree trunk 1 in order to enter into cutting engagement with the tree trunk 1. During profiling, the milling tools 5 would then have to be fed in again in the opposite direction in order to produce the side product board 4 corresponding to the setpoint extension axis 6 shown here. These infeed movements of the milling tool 5 require sufficiently large wood gaps both with respect to a leading tree trunk (not shown here) and with respect to a following tree trunk (likewise not shown here).

In order to reduce the wood gaps, the tree trunk 1 shown in view FIG. 1A is rotated out of its transport position around a rotation axis and thereby brought into a machining position shown in FIGS. 1B and 1C, in which it is moved toward the milling tools. For this purpose, the leading end region of the tree trunk 1 is rotated around a rotation axis in the direction of the milling tools 5. The rotation axis runs orthogonally to the feed direction 9 and, according to FIG. 1A, is oriented orthogonally to the plane of the image or of the straight side 2. The conceivable machining positions into which the tree trunk 1 can be brought by rotation around the rotation axis are shown in FIG. 1B and 1C.

According to FIG. 1B, the side product 4 to be profiled is oriented with its setpoint extension axis 6 parallel to the feed direction 9, and the trunk axis 7 is oriented at an angle thereto. This leads to advantages in respect of the required infeed paths of the milling tools 5 both before and during the profiling of the tree trunk 1. The infeed path before profiling is shortened since the leading end of the tree trunk can be moved in an opposed movement with respect to the milling tools 5, such that at least one of the milling tools 5 reaches the required infeed position more quickly than without a rotation of the tree trunk 1 around the rotation axis. In addition, according to FIG. 1B, it is possible to dispense entirely with infeeding of the milling tools 5 during profiling since the side product board 4 to be produced is oriented parallel to the feed direction, thus enabling it to be profiled in accordance with its setpoint extension axis purely as a result of the feed movement toward the milling tools 5.

In an alternative embodiment, the tree trunk 1 can be brought into another machining position, which is shown in FIG. 1C. Here, neither the setpoint extension axis 6 of the side product board 4 nor the trunk axis 7 is oriented parallel to the feed direction 9. In comparison with the transport position, which is shown in FIG. 1A, the angle between the setpoint extension axis 6 and the feed direction 9 is reduced, however, and this likewise leads to the advantage of a shortened infeed path of the milling tools 5 before and during milling. To enable the side product to be profiled in accordance with the setpoint longitudinal extension axis 6, infeeding of the milling tools 5 along their respective infeed axes 8 is admittedly required during milling. Nevertheless, the required infeed path can be significantly reduced in comparison with the normally required infeed path.

Another advantage which may be obtained from the machining positions shown in FIGS. 1B and 1C is associated with the fact that the milling tools 5 that are typically employed are designed as rotating milling heads, which are arranged at an acute toe angle 11 relative to the feed direction 9. In other words, the respective rotation axes of the milling heads enclose an acute angle with the plane oriented orthogonally to the feed direction.

A toe angle 11 of this kind is advantageous to enable re-cutting by the milling heads 5 to be avoided during the profiling of side product. One common challenge is that the toe angle 11 must be adjustable if the milling heads 5 are fed in along their respective infeed axis during profiling since, otherwise, re-cutting by the milling heads 5 may occur. However, rotation of the tree trunk 1 into a machining position as shown in FIGS. 1B and 1C advantageously enables a fixed setting of the toe angle since selective alignment of the tree trunk already enables an optimum relative arrangement between the side product board and the milling tools, in which re-cutting does not occur. In addition, the lack of readjustment of the angle between the milling tools 5 relative to the side product board 4 to be produced also has a positive effect on minimum wood gaps.

To carry out the method shown by means of FIGS. 1A-1C, a cutting solution for the tree trunk 1 can be determined before or after the production of the machining surface 2, and the tree trunk 1 is then machined and, in particular, the side product board 4 profiled in accordance with said cutting solution. The cutting solution can be determined by measuring the tree trunk by means of one or more geometrical sensors, followed by computational determination of an optimum arrangement and alignment of the main and side product relative to one another and relative to the tree trunk.

In order to bring the tree trunk 1 into the desired machining position as per FIGS. 1B and 1C, use is made of a conveying means comprising a plurality of feed rollers 10, which are arranged spaced apart in pairs in the feed direction. The feed rollers 10, only one of which is provided with a reference sign for the sake of clarity, can each be made to perform a rotary movement 11 and to impart a feed movement to the tree trunk via contact at their respective lateral surface. In addition, the feed rollers 10 can each be moved in translation along their own adjustment axis 13 and can be made to perform a translational movement 14 transversely to the feed direction. By a relative adjustment of one feed roller pair with respect to another feed roller pair, it is possible to rotate the tree trunk 1 during the feed movement and thereby to bring it into the machining position, in which it can be machined by the milling tools 5.

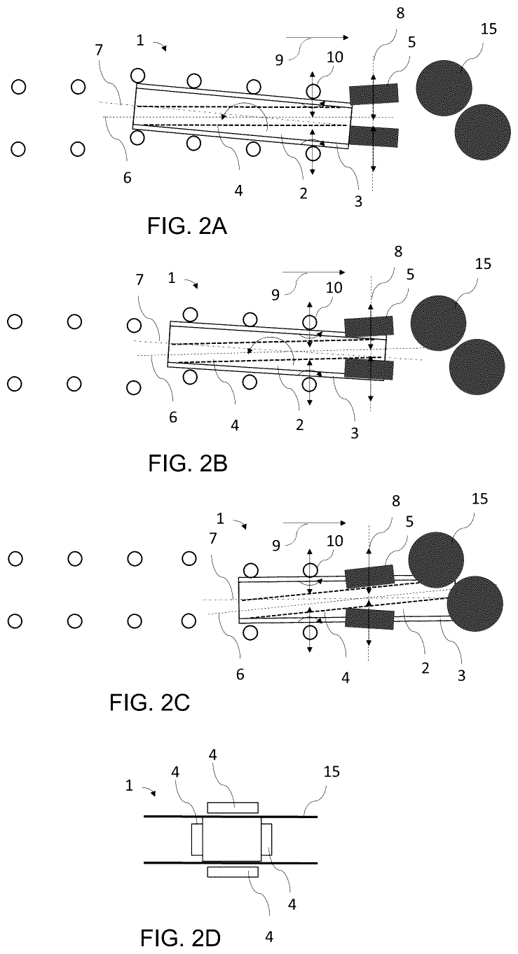

FIGS. 2A-2D show a method in which the tree trunk 1 is brought from a first machining position into a second machining position during the profiling of the side product board 4. This can take place separately or after the execution of the method steps shown in FIGS. 1A-1C.

Similarly to the statements relating to FIG. 1A, FIG. 2A shows a tree trunk 1 with a machining surface 2, which is being moved in feed direction 9. To profile a side product board 4, the tree trunk 1 is brought into a machining position by adjusting the feed rollers 10 transversely to the feed direction, wherein the explanations relating to FIGS. 1A-1C apply in a corresponding manner.

Before the profiling of the side product board 4, a cutting solution for the tree trunk 1 is determined, comprising a substantially rectilinear side product shape 1 on the tree trunk 1, which is oriented at an angle to a trunk axis 7. The tree trunk 1 is moved toward the milling tools 5 in a first machining position, in which the setpoint extension direction 6 of the side product board is oriented parallel to the feed direction and which is illustrated in FIG. 2A.

During the profiling of the side product board 4, the tree trunk 1 is brought from the first machining position into a second machining position by rotating the tree trunk 1 around the rotation axis, which runs orthogonally to the plane of the image in FIGS. 2A-2D. This is illustrated by means of FIG. 2B. The rotation of the tree trunk 1 around the rotation axis continues until the trunk axis 7 is oriented parallel to the feed direction 9 and the tree trunk 1 is therefore in the second machining position. This is shown in FIG. 2C. The side product board is profiled in accordance with the cutting solution by feeding in the two milling tools along their infeed axes 8 during the profiling of the side product board 4. In other words, the rotation of the tree trunk 1 does not have an effect on the rectilinear shape of the side product board 4. On the contrary, the milling tool 5 is adjusted along the infeed axis 8 in such a way that the desired rectilinear shape of the side product board 4 is obtained despite the rotation of the tree trunk 1.

The method illustrated by means of FIGS. 2A-2D is based on the realization that it may be advantageous if, during the profiling of the side product board 4, the tree trunk 1 is oriented with its trunk axis 7 parallel to its feed direction by appropriate control of the feed rollers 10 and of the milling tools 5 and the adjustment thereof transversely to the feed direction 9. This is necessary, for instance if, immediately after profiling, the tree trunk 1 is to be machined by means of a separating means which cannot be adjusted or can be adjusted only with great effort to enable it to be adapted to the geometry and dimensions of the tree trunk 1. In order to be able to profile the side product board 4 with an angled shape relative to the trunk axis 7 in accordance with the cutting solution during this process, provision is therefore made for the two milling tools 5 to be fed in during the profiling of the side product board 4 and the movement of the tree trunk 1 from the first into the second machining position. This makes it possible to profile the side product board 4 in a straight line while the tree trunk 1 is being rotated around the rotation axis.

The process management described above is conceivable when the tree trunk is to be profiled in the manner described above and the side product board is separated from the main product immediately thereafter by means of a saw cut in what is referred to as the preliminary cut. As illustrated by means of FIG. 2C, the tree trunk 1 is here moved along its trunk axis toward a preliminary cut sawing device 15. By means of a transverse adjustment of the tree trunk in relation to the feed direction 9, it is positioned in the second machining position in such a way that the extension axis of the side product board 4 is aligned centrally between two saw blades of the preliminary cut sawing device 15, by means of which the side product board 4 is separated from the tree trunk 1, as illustrated by means of FIG. 2D.

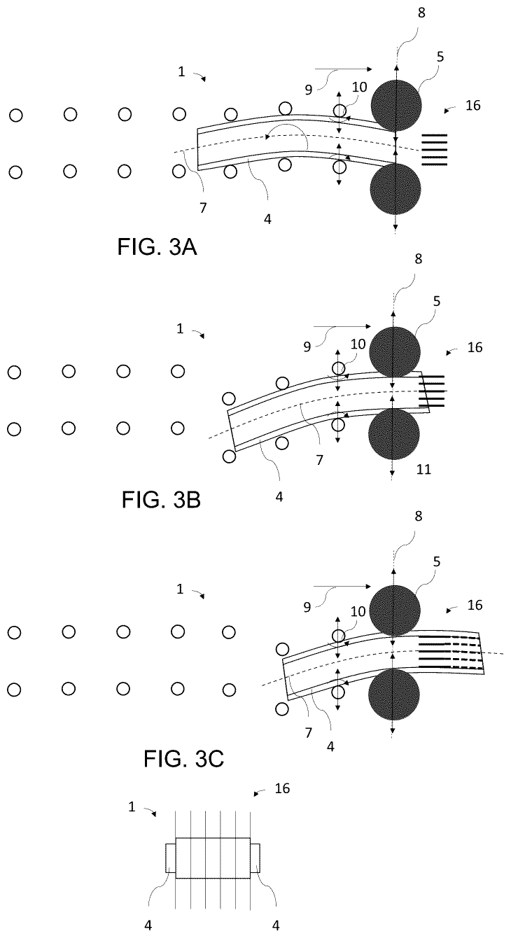

The other side product boards 4, which are arranged at an angular offset of 90 degrees to the side product boards 4 separated by the preliminary cut, are then likewise profiled and separated from the main product in what is referred to as a final cut. This is shown by means of FIGS. 3A-3D, which show a selective alignment of the tree trunk 1 in accordance with the statements relating to FIGS. 2A-2D.

In contrast to the preliminary cut, the procedure in the final cut is that cutting up of the main product by means of a plurality of saw blades oriented parallel to one another, which are part of a final cut device 16, takes place simultaneously with the saw cut which separates the side product board 4 from the main product. To avoid exposing the saw blades to excessive bending stress during the final cut on account of trunk curvature, it may be advantageous in the case of curved trunks to selectively align the tree trunk 1 for the final cut as well.

Similarly to the statements relating to FIGS. 2A-2D, before the profiling of the at least one side product board, a cutting solution for the tree trunk 1 is determined for this purpose, wherein the side product shape and the trunk shape are curved, and, in a first machining position, the tree trunk is moved toward the milling tools and, during the profiling of the side product board, is brought from the first machining position into a second machining position, in which the trunk axis and/or the side product board are/is oriented parallel to the feed direction 9 in a region which lies behind at least one of the profiling tools 5 with respect to the feed direction. Here, the side product board 4 is profiled in accordance with the cutting solution by feeding in the two milling tools 5 along their infeed axes 8 during the profiling of the side product board 4.

As can be seen from FIG. 3D, the final cut separates the side product from the main product and simultaneously divides it into a plurality of main product boards.

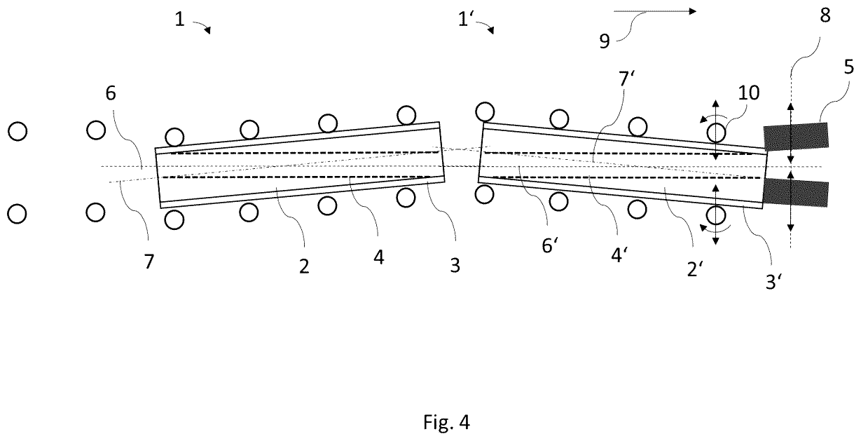

For better illustration of the advantages described with reference to FIGS. 1A-1C, FIG. 4 shows two tree trunks 1, 1′, which are moved successively in the feed direction 9 toward two milling tools 5. As shown by means of FIG. 4, the tree trunks 1, 1′ differ in the orientation of the setpoint extension axes 7 of the side product boards 4 to be profiled relative to the respective trunk axes 7.

In the case of conventional profiling of the side product boards 4 shown here, the tree trunks 1, 1′ would be oriented with their respective trunk axes 7 parallel to the feed direction 9, as a result of which, in the manner described above, the milling tools 5 would have to travel relatively long infeed paths both before and during milling.

However, if the tree trunks 1, 1′ are each brought into a machining position shown in FIG. 4, in which the setpoint extension axes 6 are oriented substantially parallel to the feed direction 9, in accordance with the statements relating to FIGS. 1A-1C, said infeed paths can be avoided completely or almost completely, and the wood gap between the tree trunks 1 can be reduced to a minimum. The statements relating to FIGS. 1A-1C apply in a corresponding manner.

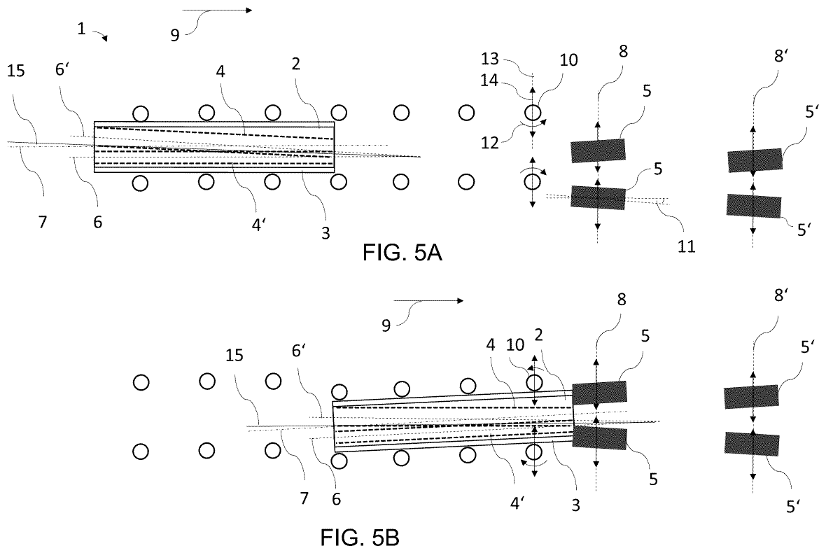

FIG. 5A shows a tree trunk 1 which, in contrast to the tree trunk 1 shown in FIGS. 1A to 4, is used to produce not just one side product board 4 but two side product boards 4, 4′, which are situated on opposite sides of the tree trunk 1. Here, the tree trunk 1 can be referred to as a model.

According to FIG. 5A, the tree trunk 1 has two machining surfaces, of which a first machining surface 2 is shown and is provided with a reference sign and the second machining surface faces away from the plane of the image and, for the sake of greater clarity, is not provided with a reference sign. The first machining surface 2 is used to produce a first side product board 4, the setpoint extension axis 6 of which is offset parallel to the trunk axis 7 in relation to the plane of the image in FIGS. 5A and 5B. The second machining surface, which is situated below the tree trunk 1 in the direction of view toward the first machining surface 2, is used to produce a second side product board 4′, the setpoint extension axis 6′ of which runs at an angle both to the trunk axis 7 and to the setpoint extension axis 6 of the first side product board 4. An angle bisector 15 extends between the setpoint extension axis 6 of the first side product board 4 and the setpoint extension axis 6′ of the second side product board 4′.

The milling tools 5 are used to profile the first side product board 4, and the milling tools 5′ are used to profile the second side product board 4′. The milling tools 5 and 5′ are offset relative to one another along a vertical axis which is orthogonal to the plane of the image. Contrary to the arrangement shown in FIGS. 5A and 5B, the milling tools 5, 5′ can be arranged at the same level along the feed axis and be offset relative to one another only along the abovementioned vertical axis that runs orthogonally to the plane of the image. The milling tools 5′ can be fed in along their respective infeed axes 8′ in a manner corresponding to the milling tools 5. For greater clarity, the milling tools 5 and the milling tools 5′ are situated in different infeed positions but, in principle, can be in any infeed position before the machining of the tree trunk 1.

In order to bring the tree trunk 1 into a machining position, it is rotated around a rotation axis as per the statements relating to FIGS. 1A to 4. Here, the rotation takes place in such a way that the tree trunk 1 is oriented with the angle bisector 15 parallel to the feed direction 9 and is moved in this position toward the milling tools 5. In the machining position of the tree trunk 1, which is shown in FIG. 5B, the setpoint extension axes 6, 6′ of the side product boards 4 and 4′ as well as the trunk axis 7 are not oriented parallel to the feed direction 9. This is shown in FIG. 5B.

Experiments have shown that the alignment of a tree trunk 1 which is shown in FIG. 5B is advantageous if the setpoint extension axes 6, 6′ of two side product boards 4 and 4′ are oriented at an angle to one another. By aligning the tree trunk 1 along the angle bisector 15, it is possible to move the trunk toward the milling tools 5, 5′ and to optimize the required infeed paths before and during milling.

If the tree trunk is moved toward the milling tools 5, 5′ in the machining position shown here, these tools each enter into engagement with the side product board 4, 4′ to be correspondingly profiled. If the side product boards 4, 4′ are to be profiled in accordance with the setpoint extension axes 6, 6′ shown here, the milling tools must be adjusted along their respective infeed axis 8. This results in a good wood yield.

However, experiments have shown that it may be advantageous to profile the side product boards 4, 4′ with a deviation relative to their setpoint extension axes 6, 6′. This is possible, for example, by bringing the tree trunk 1 into the machining position, which is shown in FIG. 5B, and feeding the milling tools into the likewise shown position before milling. During milling, however, no infeeding of the milling tools 5, 5′ takes place. This has the effect that, as indicated, the side product boards are each profiled with an actual extension axis that has an angular deviation from the respective setpoint extension axis 6, 6′.

Such an angular deviation does lead to losses of wood yield but this may be accepted for economic reasons in order to reduce the wood gap and the associated increase in plant productivity. Favorable circumstances in this context are a low wood price or the requirement for stock minimization in a wood processing facility, for example.

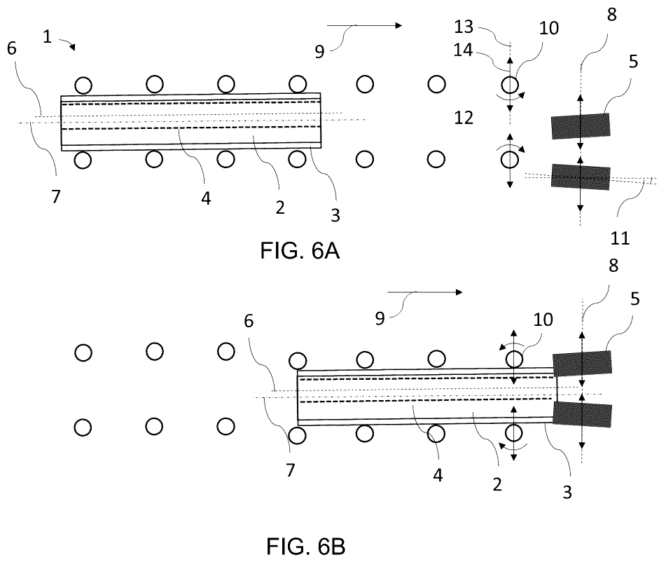

FIG. 6A shows a tree trunk 1, which is being moved in the feed direction 9 by means of a plurality of feed rollers 10 in accordance with the statements relating to FIG. 1A-1C in order to profile a side product board 4. In this case, the tree trunk has at least one machining surface 2 and two waney regions 3 adjacent thereto. Here, the setpoint extension axis 6 of the side product board 4 extends parallel to the trunk axis 7 but is offset parallel to the trunk axis 7 in a plane which is formed by the machining surface 2.

In order to bring the tree trunk 1 into the machining position, which is shown in FIG. 6B, the tree trunk 1 is adjusted by means of the feed rollers 10 along an adjustment axis which runs transversely to the feed direction, and is moved in such a machining position toward the milling tools 5. Before the milling tools 5 come into machining engagement with the tree trunk 1, they are each fed in along their infeed axis 8. During this process, the movement of the tree trunk 1 and of the milling tools 5 results in an opposed movement, as a result of which the milling tools 5 have to travel shortened infeed paths in comparison with conventional infeed.

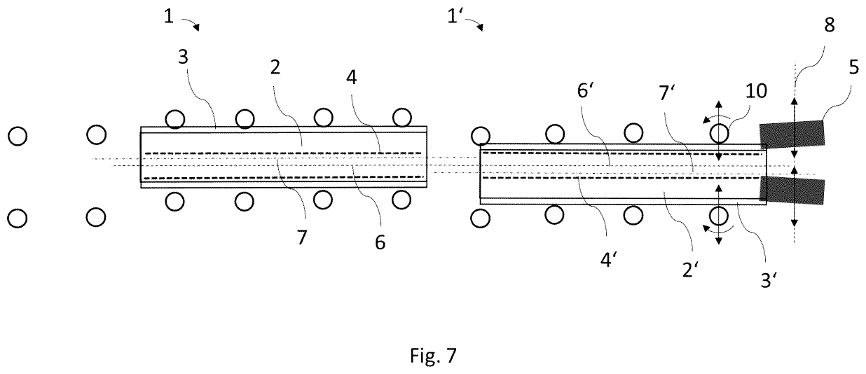

Like FIG. 4, FIG. 7 shows two tree trunks 1, which are moved toward two milling tools 5 with a spacing formed by a wood gap. The tree trunks 1 are to be machined in such a way that in each case at least one side product board 4 is profiled. In the case of both tree trunks 1, the setpoint extension axes 6 are offset parallel to the respective trunk axis 7. To reduce the wood gap, the tree trunks 1 are shifted in translation in accordance with the above statements relating to FIGS. 6A-6B, as a result of which the infeed of the milling tools 5 before milling must be reduced, and there is no need for any infeed at all during milling.

1. A method for producing lumber from a tree trunk (1), the method comprising:
producing at least one machining surface (2) on the tree trunk (1) by removing a slab region;
during a feed movement in a feed direction (9), moving the tree trunk (1) toward at least two milling tools (5), which are each feedable in along an infeed axis (8), and milling out two waney regions (3) adjacent to the machining surface (2) and profiling at least one side product board (4);
separating the side product board (4) from the tree trunk (1) by a saw cut; and
during the feed movement and before the side product board is profiled, bringing the tree trunk (1) from a transport position into a machining position by moving the tree trunk around and/or along at least one adjustment axis, which runs orthogonally to the feed direction (9), and, as a result, shifting at least one leading region of the tree trunk (1) transversely to the feed direction (9) in a direction of at least one of the milling tools (5).

2. The method as claimed in claim 1, further comprising:
moving at least first and second ones of the tree trunks (1, 1′) successively in the feed direction, and profiling one said side product board on each of the first and second tree trunks (1, 1′) by at least one of the milling tools;
feeding the at least one of the milling tools in along the infeed axis thereof during the profiling of the side product board of the first tree trunk (1′); and
and, before the profiling of the side product board of a second tree trunk (1), bringing the second tree trunk from the transport position into the machining position by moving the second tree trunk around and/or along the adjustment axis, which runs orthogonally to the feed direction (9), and, as a result, shifting the leading region of the second tree trunk (1) transversely to the feed direction (9) in the direction of at least one of the milling tools (5).

3. The method as claimed in claim 1, further comprising not feeding at least one of the milling tools in while the at least one milling tool is in a wood gap between the first tree trunk (1′) and the second tree trunk (1).

4. The method at least as claimed in claim 1, further comprising:
moving at least first and second ones of the tree trunks (1, 1′) successively in the feed direction, and profiling one said side product board on each of the two tree trunks (1, 1′) by at least one of the milling tools;
feeding the milling tool in along an infeed axis after the profiling of the side product board of the first tree trunk (1′);
bringing the second tree trunk (1) into the machining position by moving the second tree trunk around and/or along the adjustment axis, which runs orthogonally to the feed direction (9), and, as a result, shifting the leading region of the second tree trunk (1) transversely to the feed direction (9) in the direction of the at least one milling tool (5); and
feeding the milling tool in while the milling tool is in a wood gap between the first tree trunk (1′) and the second tree trunk (1).

5. The method at least as claimed in claim 4, wherein the shifting of the leading region of the second tree trunk (1) transversely to the feed direction (9) in the direction of the at least one milling tool (5), is in a direction counter to the infeed of the milling tool (5).

6. The method as claimed in claim 1, wherein the tree trunk (1) is brought into the machining position by rotating the tree trunk around a rotation axis which is orthogonal to the feed direction (9) and feeding in at least one of the milling tools (5) along the respective infeed axis (8) thereof, which runs orthogonally to the feed direction (9) of the tree trunk (1) and the rotation axis.

7. The method at least as claimed in claim 6, further comprising:
before the profiling of the at least one side product board (4), determining a cutting solution for the tree trunk (1), the cutting solution comprising a substantially rectilinear side product shape on the tree trunk (1), which is oriented at an angle to a trunk axis, and
rotating the tree trunk (1) around the rotation axis such that a setpoint extension axis (6) of the side product board (4) in the machining position of the tree trunk (1) is oriented parallel to the feed direction (9), and
profiling the side product board (4) in accordance with the cutting solution by moving the tree trunk in the machining position toward at least one of the milling tools and by the milling tool being fixed in relation to the infeed axis thereof during the profiling of the side product board (4).

8. The method at least as claimed in claim 6, further comprising:
before the profiling of the at least one side product board, determining a cutting solution for the tree trunk (1), the cutting solution comprising a substantially rectilinear side product shape on the tree trunk (1), which is oriented at an angle to a trunk axis, and
rotating the tree trunk (1) around the rotation axis such that a setpoint extension axis (6) of the side product board (4) in the machining position is not oriented parallel to the feed direction (9).

9. The method at least as claimed in claim 8, further comprising:
profiling the side product board (4) in accordance with the cutting solution by feeding in at least one of the milling tools (5) along the infeed axis (8) thereof during the profiling of the side product board (4), or
profiling the side product board (4) deviating from the cutting solution, wherein at least one of the milling tools (5) is fixed in relation to the infeed axis thereof during the profiling of the side product board (4).

10. The method at least as claimed in claim 6, wherein the milling tools (5) each comprise a rotating milling head, rotation axes of which in each case enclose an acute angle, which is fixed with a plane which is oriented orthogonally to the feed direction (9).

11. The method as claimed in claim 1, further comprising:
producing two of the machining surfaces (2) which face in opposite directions on the tree trunk (1) by removing two of the slab regions;
the moving of the tree trunk (1) in the feed direction (9) includes moving the tree trunk (1) toward at least four of the milling tools (5, 5′) and, during this process, four of the waney regions (3) adjacent to the machining surfaces are milled out, whereby two of the side product boards on the tree trunk (1) are profiled; and
the separating includes separating two of the side product boards (4, 4′) from the tree trunk by two of the saw cuts,
wherein during the feed movement and before the side product boards (4, 4′) are profiled, the bringing of the tree trunk (1) into position includes bringing the tree trunk (1) from the transport position into the machining position by moving the tree trunk (1) around and/or along the adjustment axis such that at least the leading region of the tree trunk (1) is shifted transversely to the feed direction (9) in the direction of at least two of the milling tools (5, 5′).

12. The method as claimed in claim 11, further comprising:
before the profiling of the longitudinal sides of the side product boards (4, 4′), determining a cutting solution for the tree trunk (1), which comprises two substantially rectilinear nonparallel side product shapes along in each case one setpoint longitudinal extension axis (6, 6′), and
rotating the tree trunk (1) around a rotation axis, which runs orthogonally to the feed direction, such that, in the machining position, the setpoint extension axes (6, 6′) of the side product boards define an angular range which encloses the feed direction (9).

13. The method as claimed in claim 12, wherein the feed direction (9) is oriented parallel to an angle bisector between the setpoint longitudinal extension axes (6, 6′).

14. The method at least as claimed in claim 12, wherein
the tree trunk (1) is machined in accordance with the cutting solution, and the side product boards (4, 4′) are produced in accordance with the setpoint extension axes by feeding in at least two of the milling tools, which serve to profile different side product boards (4, 4′), along respective infeed axes (8) thereof during the milling of the tree trunk, or
the tree trunk (1) is machined deviating from the cutting solution, in that at least two of the milling tools, which serve to profile different side product boards (4, 4′), are fixed along the respective infeed axes during the feed movement of the tree trunk (1), and the side product boards (4, 4′) are each produced with an actual longitudinal extension axis which has an angular deviation from the respective setpoint longitudinal extension axes, wherein the angular deviation corresponds to half the angle between the setpoint longitudinal extension axes (6, 6′) of the side product boards (4, 4′).

15. The method as claimed in claim 1, wherein
the tree trunk (1) is at least partially adjusted by being shifted along a translation axis, which runs orthogonally to the feed direction and orthogonally to the rotation axis.

16. The method as claimed in claim 15, further comprising:
before the profiling of the at least one side product board (4), determining a cutting solution for the tree trunk, which comprises a side product shape on the tree trunk (1), wherein a setpoint extension axis (6) of the side product board (4) runs substantially parallel to a trunk axis (7), and
bringing the tree trunk into the machining position by shifting the setpoint extension axis of the tree trunk along the translation axis in dependence on the leading tree trunk (1′).

17. The method at least as claimed in claim 1, wherein the tree trunk (1) is moved in the feed direction by a plurality of feed roller pairs, of which at least two of the feed roller pairs are arranged spaced apart along the feed direction, and the tree trunk is brought into the machining position by shifting at least one of the feed roller pairs relative to the respective other feed roller pair and/or shifting the at least two feed roller pairs jointly transversely to the feed direction.

18. A method for producing lumber from a tree trunk (1), the method comprising:
producing at least one machining surface (2) on the tree trunk (1) by removing a slab region, and
during a feed movement in a feed direction (9), moving the tree trunk (1) toward at least two milling tools (5), which are feedable in along respective infeed axes (8), whereby two waney regions (3) adjacent to the machining surface (2) are milled out and at least one side product board (4) is profiled;
separating the side product board (4) is separated from the tree trunk (1) by a saw cut;
before the profiling of the at least one side product board, determining a cutting solution for the tree trunk (1), the cutting solution comprising a side product shape on the tree trunk (1); and
in a first machining position, the tree trunk (1) is moved toward the milling tools and, during the profiling of the side product board (4), the tree trunk (1) is brought from the first machining position into a second machining position by rotating the tree trunk (1) around a rotation axis, which runs orthogonally to the feed direction; and
the side product board (4) is profiled in accordance with the cutting solution by feeding in the two milling tools (5) along the respective infeed axes (8) during the profiling of the side product board.

19. An apparatus for producing lumber from a tree trunk (1), the apparatus comprising:
a separating cutter which is configured to separate a slab from a tree trunk (1) and to produce at least one machining surface (2), and
a conveyor configured to impart a feed movement to the tree trunk (1) along a feed direction (9), and
at least two milling tools (5) arranged such that, during the feed movement, the tree trunk (1) is adapted to be moved toward the milling tools (5) and two waney regions adjacent to the machining surface are adapted to be milled out and longitudinal sides of a side product board (4) are thereby profiled, and
a saw that is adapted to separate the side product board (4) from the tree trunk (1),
wherein the conveyor is adapted to adjust the tree trunk (1) around and/or along at least one adjustment axis, which runs orthogonally to the feed direction, and such that at least one leading region of the tree trunk is adapted to be shifted transversely to the feed direction.
